(19) United States
(12) Patent Application Publication
(10) Pub. No.: US 2005/0193304 A1
(43) Pub. Date: Sep. 1, 2005

(54) Circuit modeling apparatus, systems, and methods

(75) Inventors: Jacob Abraham, Austin, TX (US); Vivekananda Vedula, Austin, TX (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Board of Regents, The University of Texas System

(21) Appl. No.: 11/017,378

(22) Filed: Dec. 20, 2004

Related U.S. Application Data
(60) Provisional application No. 60/531,084, filed on Dec. 19, 2003.

(51) Int. Cl. G06F 11/00; G06F 17/50

(52) U.S. Cl. 714/738; 703/2

(57) ABSTRACT

Apparatus and systems, as well as methods and articles, may perform operations including selecting a monitor associated with a property of a circuit module, augmenting the circuit module with the monitor to provide an augmented circuit, searching for a test for an output of the augmented circuit to find a sequence of states having a length up to n, establishing a witness to the property if the test is found, and if no test is found to exist within the sequence of states, determining the property to be invalid or false for a bound of n.

### RELATED APPLICATION

This application claims priority to U.S. Provisional Application Ser. No.: 60/531,084 (entitled: CIRCUIT MODELING APPARATUS, SYSTEMS, AND METHODS, filed Dec. 19, 2003) which is incorporated herein by reference.

### TECHNICAL FIELD

Various embodiments relate generally to apparatus, systems, and methods used to verify circuit operation, including designing and testing circuits.

### BACKGROUND INFORMATION

Designers are often interested in locating problems or “bugs” in their circuit designs. For example, model checking is a popular technique to verify that certain properties expressed in temporal logic hold true. However, due to the limitations of finite state machine representation, the use of such techniques may be impractical for even moderately large designs. Alternative approaches to finding counterexamples have been proposed, such as SAT (satisfiability)-based LTL (linear time temporal logic) property checking, including BMC (bounded model checking). However, in many instances the use of such approaches remains memory intensive and cumbersome. Thus, there is a need for apparatus, systems, articles, and methods to more efficiently verify the operation of circuits having large numbers of elements.

### BRIEF DESCRIPTION OF THE FIGURES

FIG. 1 illustrates a variety of Computational Tree Logic (CTL) formulas according to various embodiments of the invention.

FIGS. 2-7 illustrate monitors for existential properties according to various embodiments of the invention.

FIG. 8 comprises a block diagram of apparatus and systems according to various embodiments of the invention.

FIGS. 9 and 10 are flow diagrams of several methods to test for unbounded properties according to various embodiments of the invention.

FIG. 11 is an exemplary generic monitor written in the Verilog hardware description language for checking unbounded liveness according to various embodiments of the invention.

FIG. 12 is a block diagram of an article according to various embodiments of the invention.

### DETAILED DESCRIPTION

Various embodiments disclosed herein may operate to formally verify safety and liveness properties of designs using sequential ATPG (automatic-test pattern generation) tools and operations. The properties may be mapped into a monitor circuit with a target fault so that finding a test for the fault corresponds to formally establishing the property. While existing methodologies for formal property checking may be severely limited in the size of circuits they can handle, the various approaches described herein may permit a more practical approach using ATPG tools to formally check properties of relatively large modules, in a framework which is compatible with the existing design flow.

Many properties can be formally checked. For example, safety and liveness properties can be used to express system behavior. Safety properties assert what the system is permitted to do, or equivalently, what it may not do. Thus, a safety property may express the fact that something bad will never happen in a system. For example, safety properties may be satisfied by a system which does nothing. Restriction to only producing correct answers is an example of a safety property.

Liveness properties assert what the system must do. Thus, a liveness property expresses the behavior whereby something good will eventually happen. For example, termination is an example of a liveness property. These properties are generally specified using temporal logic and variations, since digital systems may receive inputs and produce outputs in a continuous interaction with their environment. For instance, using this logic one can express the assertion that if proposition p holds in the present, then proposition q holds at some instant in the future.

In LTL, the notion of time is that of a linearly ordered set (e.g., a possible sequence of states). Four operators may be used to describe LTL properties in dealing with hardware verification, F, G, U and X. Thus, if p comprises an arbitrary logic proposition or property which may be subjected to testing to determine whether it is true for all possible states, or for which a counterexample may be sought, and a property comprises a combination ofp with tense operators and path quantifiers, the following conditions may be defined:
Fp: comprises an operator that is true in the present if p is true at some moment in the future.
Fq: comprises an operator that is true in the present if at some moment in the future q is true.
Gp: comprises an operator that is true in the present if p is true at every moment in the future.
Gq: comprises an operator that defines q to be true at every moment of the future.
pUq: comprises an operator that defines q to be true at some moment in the future, until which time p will be true. The U operator is called a “weak until” if q does not necessarily hold in the future, and a “strong until” if q definitely holds in the future.
Xq: comprises an operator that is true in the present if q is true in the next instant of time.

Another temporal logic framework, CTL, may be used to express the fact that at each instant of time there exist many possible futures. Each branch can be defined as a maximal linearly ordered set of states. Truth or falsehood of tense formulas may be defined as being relative to a given branch of the tree ordered frame. Thus, the following definitions may be observed:
A: comprises a universal property or path quantifier that stands for every path in a CTL computation tree.
E: comprises an existential property or path quantifier that stands for the existence of some path in a CTL computation tree.
Aq: comprises a property where q is necessarily true (e.g., along all branches).
Eq: comprises a property where q is possibly true (e.g., along some branch).

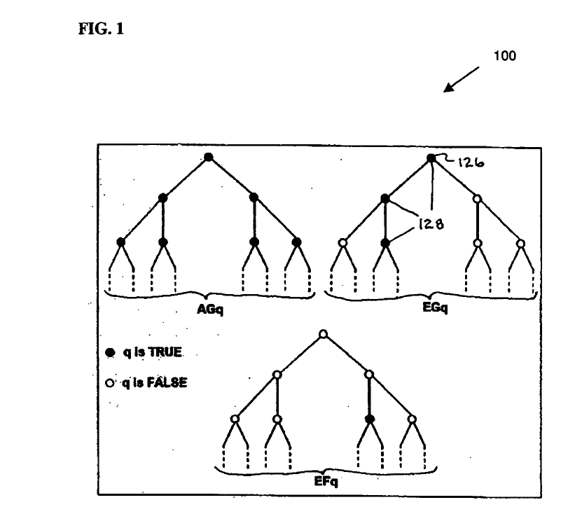

FIG. 1 illustrates a variety of CTL formulas 100 according to various embodiments of the invention. For example, the formula EGq is true in the top state 126 if there exists a sequence of states 128 for which q holds true in each state.

To illustrate the use of these operators to express safety and liveness properties, consider the design of a processor. It may fetch instructions, decode them, fetch operands, execute instructions, write results back, and return to the fetch state. The design of the control program for the processor may include the above sequence of states, as well as illegal states (depending on the state assignment).

An example of a safety property could be that the processor never enters an illegal state, Si. This can be expressed as G [symbol] Si in LTL. To find a counterexample (a bug or problem), we can check for the negative of the property, expressed in CTL as EFSi: i.e., along some execution path, at some time in the future, the processor enters an illegal state.

An example of a liveness property could be that the processor never hangs, i.e., it will always return to the fetch state, Sf. This can be expressed in LTL as FSf. A counterexample for this would be an infinite sequence of states which does not include the fetch state, expressed in CTL as EG [symbol] Sf, i.e., along some execution path, for all futures, the fetch state is not reached.

The process of analyzing a design for the validity of properties stated in temporal logic is often called model checking. The input to a model checker may be a formal description of the design, and the result can be a set of states which satisfy a given property, or a witness of a sequence which violates the property (leading to a conclusion that the property is invalid).

Model checking can be done by explicitly checking if a given property holds for each state, but this is usually only practical for designs having a small number of states. Using OBDDs (ordered binary decision diagrams) permits the analysis of designs without explicitly enumerating their states. However, OBDDs can be vulnerable to an explosion of the number of states for even moderately complex designs. In practice, the primary benefit of model checking is to find bugs, rather than providing formal proofs establishing design correctness. Moreover, designers usually know the bound on the number of states within which a property should hold. This leads to the idea of BMC (bounded model checking) which exploits these ideas as one approach to design verification.

BMC is based on searching for a counter-example in a finite unfolding (with respect to time steps) of the design under verification. By systematically increasing the unfolding depth to a bounded integer k, this approach checks whether the target can be reached in k+1 time steps. Such an approach may include a SAT-based bounded model checking procedure for checking LTL properties, where a set of propositional clauses can be generated from the design under consideration, and a SAT solver may be used to find a satisfying variable assignment in polynomial time. For example, checking the “universal” property of the type F(x=0) may be equivalent to finding a witness for the “existential” property of the type EG(x≠0). A BMC checker with a SAT solver has been reported as superior to one with a BDD package.

A counterexample to a safety property is a case where a system acts in a manner which is not permitted (e.g., something bad happens in a circuit). Using a previous example, the bug (the “bad” event) might be that a processor enters an illegal state. An ATPG tool could be used to find the counterexample by justifying the illegal state to a starting state (or the X-state).

A liveness property can be checked directly (examining all states to ensure that a given property holds), or a counterexample may be found (e.g., a sequence of states which contradicts the property). Using the processor example, a counterexample to the property that the processor will eventually go to the start state is a sequence of states which does not include the start state. It is not obvious how ATPG can be used to find such a sequence, even when the number of states in the sequence is bounded.

As will be shown hereinbelow, such problems may be solved by embodiments that fit into the normal design flow may be realized. For example, an existing ATPG tool, using a circuit description compatible with the tool, can be supplemented by adding a small circuit to guide the ATPG tool into checking for a desired property. For example, consider properties stated as temporal logic formulas of the type Ap, where p is a restricted path formula in which the only state sub-formulas are atomic propositions. Some embodiments may then operate to map both safety and liveness properties, as well as a bound on the number of states to be verified, into a monitor circuit with a target fault, so that an existing ATPG tool can be used to test for the fault. A test for the fault may becomes a witness for the property. If the fault is determined to be untestable, the property may be guaranteed to hold within the bound. If the ATPG operation aborts, this may not reveal anything about the property.

Mapping formal properties into monitor circuits with target faults may be accomplished by those of skill in the art after reading and understanding the content of this disclosure, since many organizations use monitors to check the outputs of simulation. Since the use of an ATPG is well-suited to searching for a test (e.g., a counterexample), the fact that “universal” properties can be reduced to “existential” properties will be utilized. Thus, in order to test for the LTL property Fp with a bound of n (i.e., at some time in the future, within n cycles, p will be true), an ATPG can be used to find a sequence of length n, where p is not true (i.e., an attempt is made to find a witness for EG [symbol] p).

Finite state machines representing the monitor circuits for each of the properties EFp, EGp, Xp, and pUq are described below for a bound of n. If the final (absorbing) state is reached, the property can be satisfied. The fault to be tested could then comprise the output of a gate which decodes the final, absorbing state.

ATPG operations described herein may assume that the circuit starts in an unknown state (all “Xs”), and then operate to find a reset or synchronization sequence that leads to a known state. Thus, in some embodiments of the checking framework, the circuit may begin in the unknown state, with the monitor in its starting state. If a test is found for the target fault corresponding to a property, there should be a sequence, starting in the unknown state, which is a witness to the property. The state (or set of states) which is within n cycles of the final state may then satisfy the property. Such a framework is consistent with the one used in classical model checking, which tries to find the set of states which satisfy a property. If ATPG determines that the target fault corresponding to a property is untestable, then there is no sequence of states of length ≦n which will satisfy the property. Finally, if the ATPG operation aborts, no information is revealed about the property.

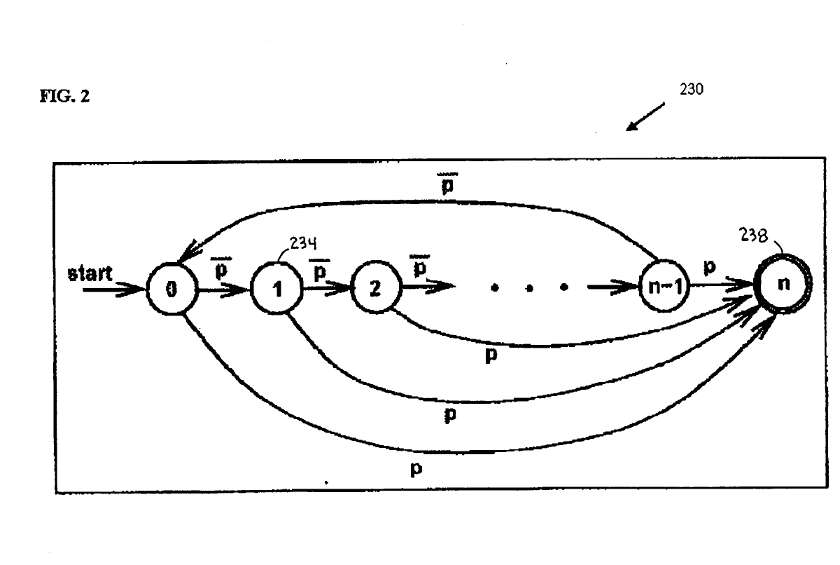

FIGS. 2-7 illustrate monitors for existential properties according to various embodiments of the invention. In each case discussed herein, the term “monitor” may be replaced by “finite state machine (FSM)” or “circuit”. For example, FIG. 2 illustrates a monitor 230 for the EFp property according to various embodiments. In this case, the search may begin at the first state 234, and if at any time p is satisfied, the process can proceed directly to the final state 238 (e.g., state n). The target fault for the ATPG would be a “stuck fault” (well-known to those of skill in the art) on the output of a gate decoding the final state 238. If the ATPG finds a test for the fault, the property can be satisfied; if the fault is untestable, then p will not be true for any sequence sequence of length ≦n.

It should be noted that if a bound was not included (e.g., state n) then EFp could be checked by creating a combinational subcircuit that holds true if p is true, and then asking the ATPG to generate a test for “stuck-at-0” (e.g., if the fault exists, the output is stuck at a value of zero—a test would attempt to force the output to a value of one) at the output of the circuit, which is an approach taken by previous attempts to check for safety properties. The state machine in this case incorporates the bound n and is consistent with state machines checking for liveness properties.

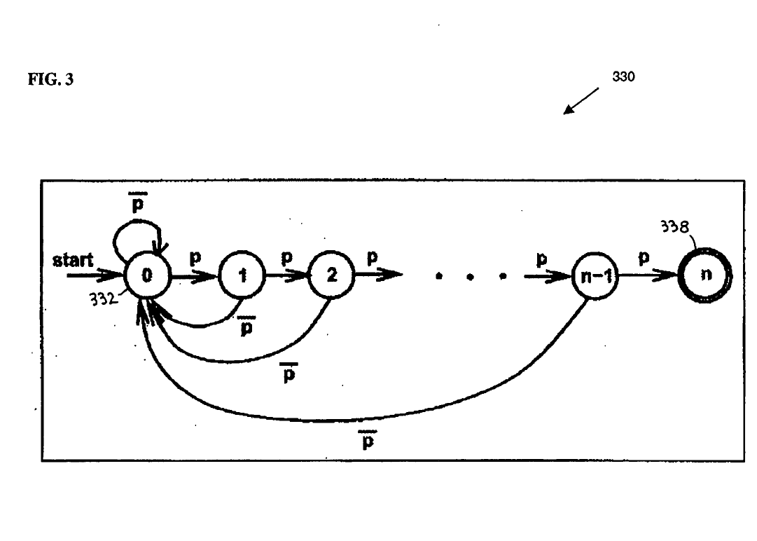

FIG. 3 illustrates a monitor 330 for the EGp property for a bound of n according to various embodiments. Previously, it was unknown how such a liveness property could be checked using ATPG. For the monitor 330, operation may progress from the start state 332 for n states to the final state 338 (e.g., state n) only if p is true at each state. If a state is entered where p is not true, the process should return directly to the start state 332.

In order to see why the monitor 330 can force the ATPG to generate a witness for EGp, observe the cases where the ATPG may find a test for a fault on the gate decoding the final state 338, and where no test can be found. For example, assume the ATPG finds a test for the fault. Then the test will include a sequence of n states where p is true at each state, which comprises a witness for EGp. If the test from the unknown state is longer than n states, the last n states would comprise the witness sequence, and the set of states at the beginning of the sequence would satisfy EGp. However, suppose the ATPG operation determines that the fault is untestable. In that case, it no sequence of inputs will produce a sequence of n states where p holds true at each state of the sequence, indicating that the property is not satisfiable in n states.

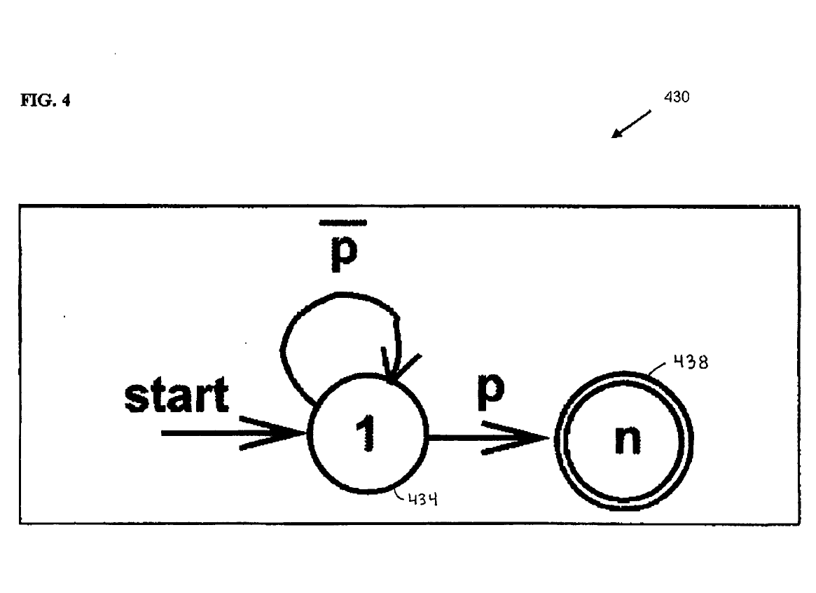

FIG. 4 illustrates a monitor 430 for the EXp property according to various embodiments. In this case, it can be seen that the test produced by the ATPG indicates a state where p is true in the next state (e.g., final state 438) after the first state 434.

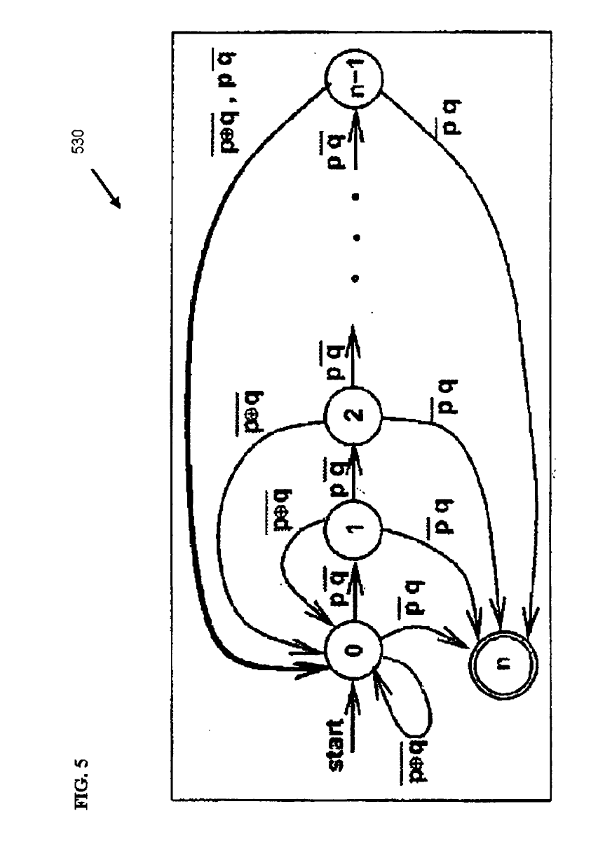

FIG. 5 illustrates a monitor 530 for the EpUq property according to various embodiments. This case serves to implement the “strong until” function, which is typically of interest to circuit designers. This monitor circuit should guide the ATPG into finding a witness for the property in a manner similar to or identical to that described for the EGp property monitor of FIG. 3.

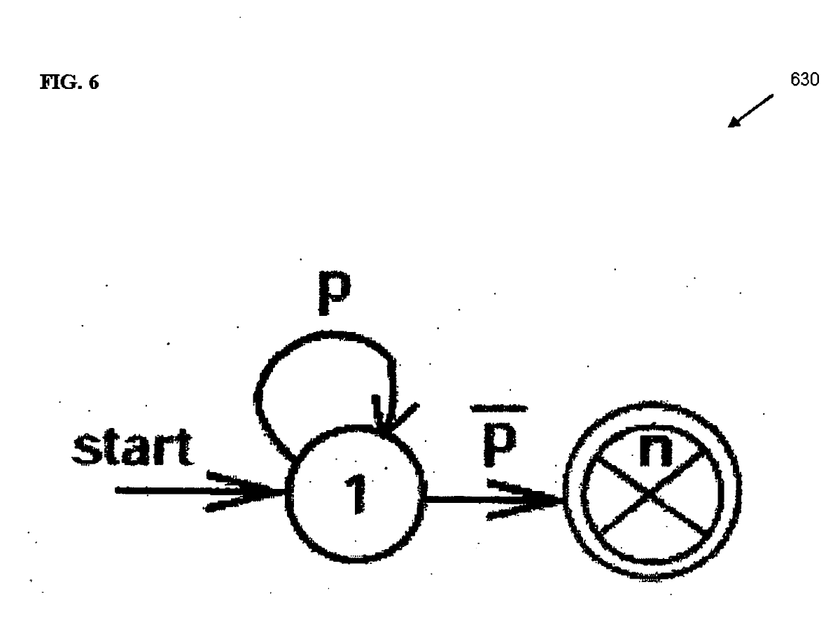

FIG. 6 illustrates a monitor 630 for the unbounded AGp property according to various embodiments. In this case the AGp property is checked to find a counterexample where p is false at some point in the future (for any number of states n).

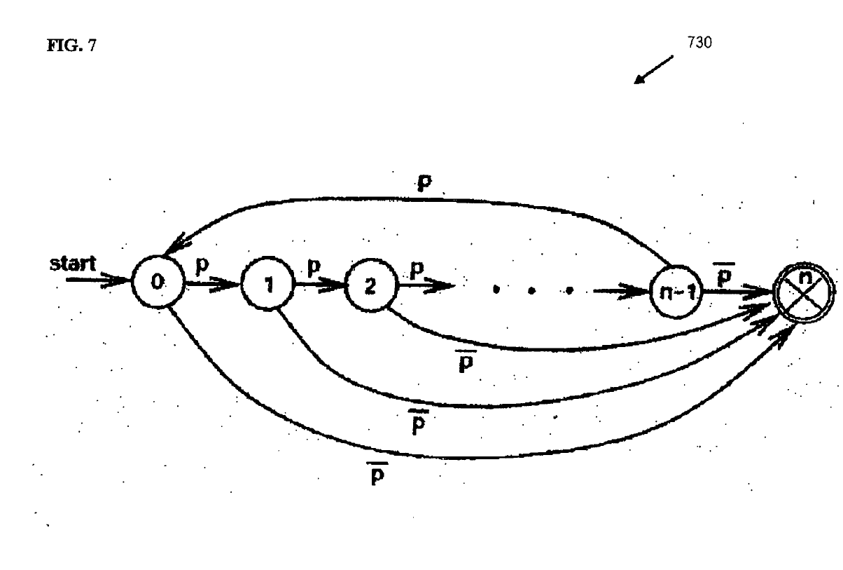

FIG. 7 illustrates a monitor 730 for the bounded AGp property according to various embodiments. In this case the AGp property is checked to find whether p is true for any input sequence of length n, which is equivalent to finding a counterexample to the AGp property.

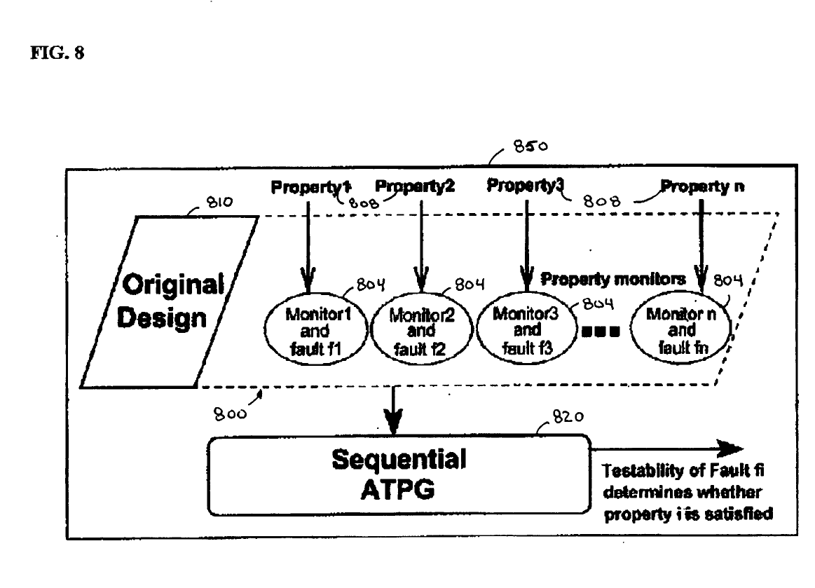

FIG. 8 comprises a block diagram of apparatus 800 and systems 850 according to various embodiments of the invention. While the original circuit design to be verified does not have to be modified, one or more property monitors for the properties of interest (e.g., using the relevant signal names from the original design) may be generated to implement the activities described herein. The original circuit design and the monitors with the target faults may then be processed by a sequential ATPG tool, known to those of skill in the art, and the result of the test generation for the faults can be used to determine whether the corresponding property is satisfied.

Thus, in some embodiments, an apparatus 800 may include one or more counterexample monitors 804 for one or more properties 808, and a circuit module 810 (e.g., the circuit to be verified) associated with the properties 808 and coupled to the counterexample monitors 804. The circuit module 810 may include a processor.

The counterexample monitors 804 may include temporal logic, and the properties 808 may include one or more propositional formulas p augmented by tense operators selected from one or more of F, G, U, and X (e.g., LTL operators), and path quantifiers selected from one or more of A and E (e.g., CTL properties). Thus, the properties 808 may be selected from the group including: EFp, EGp, EXp, EpUq, AFp, AGp, AXp, and ApUq. The properties 808 may include one of a safety property and a liveness property, including an unbounded liveness property, which may be satisfied for a sequence of states including a repeating state.

Other embodiments may be realized. For example, a system 850 may include one or more of the apparatus 800 as well as an ATPG 820 capable of being communicatively coupled to the circuit module 810. The ATPG 820 may comprise a sequential ATPG, and/or a computer. Thus, the system 850 may comprise a computer, such as a digital computer, a digital signal processor, as well as a hybrid computer (e.g., digital/analog). The system 850 may also comprise one or more circuit modules 810 to be operationally verified (in terms of operational states and/or other operational characteristics) by monitoring properties 808 associated with each one of the circuit modules 810 according to the apparatus, articles, methods, and systems of various embodiments. Coupling may be electric, mechanical, fluid, thermodynamic, or a combination of these.

The path quantifiers A, E; tense operators F, G, U, X; operators Fp, Fq, Gp, Gq, pUq, Xq; properties Aq, Eq, AFp, AGp, AXp, ApUq, EFp, EGp, EpUq, EXp; illegal state Si; fetch state Sf; CTL formulas 100, EGq; states 126, 128, n; monitors 230, 330, 430, 530, 630, 730; first states 234, 434; final states 238, 338; start states 332; apparatus 800; counterexample monitors 804; properties 808; circuit module 810; ATPG 820; and system 850 may all be characterized as “modules” herein. Such modules may include hardware circuitry, single or multi-processor circuits, memory circuits, software program modules and objects, firmware, and combinations thereof, as desired by the architect of the apparatus 800 and system 850, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments.

It should also be understood that the apparatus and systems of various embodiments can be used in applications other than integrating memory management control functions into a memory module; and thus, various embodiments are not to be so limited. The illustrations of apparatus 800 and systems 850 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

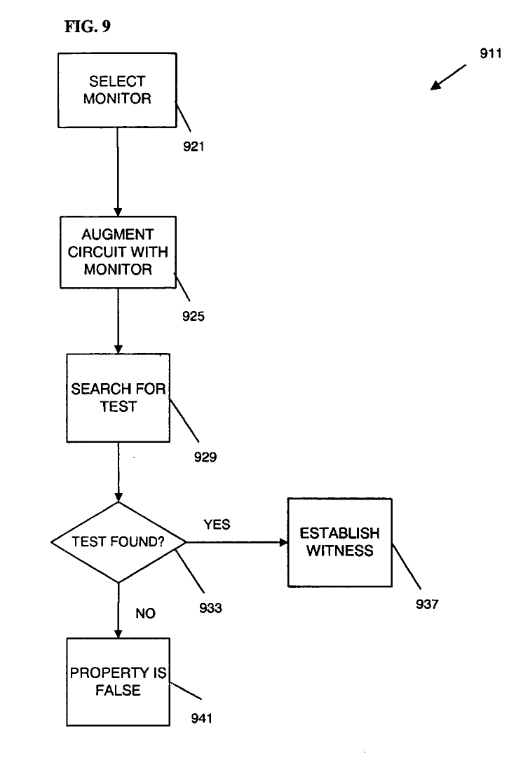

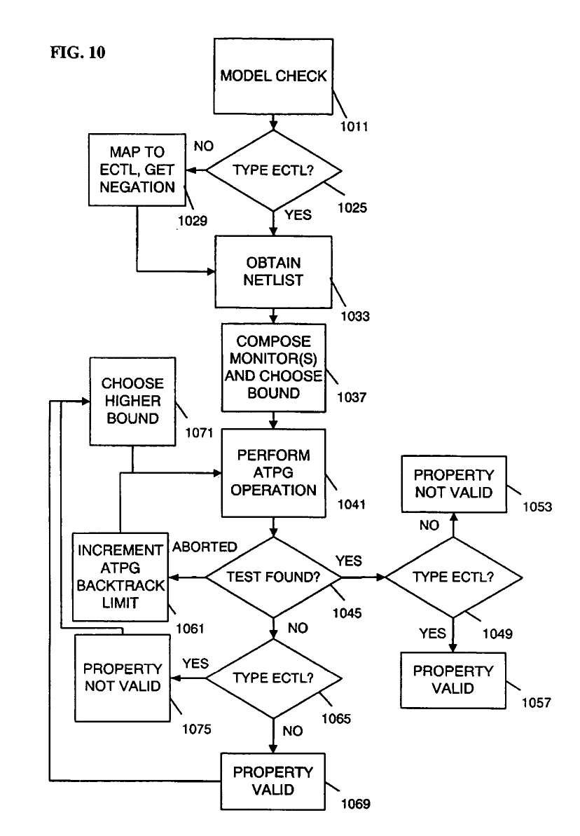

Some embodiments may include a number of methods. For example, FIGS. 9 and 10 are flow diagrams of several methods 911 and 1011 to test for unbounded properties according to various embodiments of the invention. The properties can be expressed using temporal logic, such as LTL and CTL. In some embodiments, the test may comprise finding a counterexample to a property of a circuit module (or model of a circuit), including a universal property associated with the property to be validated.

The method 911 may begin at block 921 with selecting a monitor associated with a property of a circuit module. The property may include a propositional formula p augmented by tense operators selected from one or more of F, G, U, and X, as well as one or more path quantifiers, including A and E. Thus, the property may be selected from a group including: EFp, EGp, EXp, EpUq, AFp, AGp, AXp, and ApUq.

The method 911 may then proceed with augmenting the circuit module with the monitor to provide an augmented circuit at block 925. The method 911 may continue with searching for a test for an output of the augmented circuit to find a sequence of states having a length up to n at block 929. The search may be conducted from a given starting state, which may comprise an unknown starting state (which may imply that the property will be true when starting from any possible state).

In some embodiments, the method 911 may include, if the test is found within the sequence of states at block 933, establishing a witness to the property (e.g., determining the property, which may be a safety property and/or a liveness property, to be true) at block 937. The property may be expressed using temporal logic. If the test is not found within the sequence of states at block 933, the method 911 may include determining the property to be false (invalid) for a bound of n at block 941.

Many variations are possible. For example, the method 911 may be extended to find unbounded liveness properties. Some methods (described previously) may operate to check if the property holds true for a bound of n states. In order to prove that a property holds for an arbitrary number of states n, a search may be conducted to find a loop (i.e., a sequence of states where one of the states is repeated) in which the property is satisfied.

In some embodiments, a method 1011 may begin with determining whether the property chosen is of type ECTL (existential CTL, which a restricted form of CTL, not having universal quantifiers) at block 1025. If not, then the property may be mapped to ECTL and its negation obtained in block 1029. The method 1011 may then be directed to block 1033. If the property is of type ECTL, then the method may proceed directly to block 1033, where a gate-level netlist of the predicate terms for the circuit to be checked may be obtained.

The method 1011 may include composing gate-level monitor circuits corresponding to the circuit to be checked, as well as choosing a bound of n states, at block 1037. Then an ATPG operation may be performed at block 1041 to see if a test for the chosen property can be found within n states at block 1045.

If the test is found within n states, then a determination may be made as to whether the property is of type ECTL at block 1049. If not, then it can be determined that the property is not valid at block 1053. If the property is of type ECTL, then it can be determined that the property is valid at block 1057. If no test is found, and the ATPG aborts, then the backtrack limit of the ATPG may be incremented, and the method may continue to block 1041, where another ATPG operation may be performed.

If the test is not found within n states, and the ATPG does not abort, then a determination may be made as to whether the property is of type ECTL at block 1065. If not, then it can be determined that the property is valid within the bound n at block 1069, and the method 1011 may proceed to choosing a higher bound for n at block 1071. The method 1011 may then proceed to performing another ATPG operation at block 1041. If the property is of type ECTL, then it can be determined that the property is not valid within the bound n at block 1075, and the method may proceed to block 1071.

It should be noted that the methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

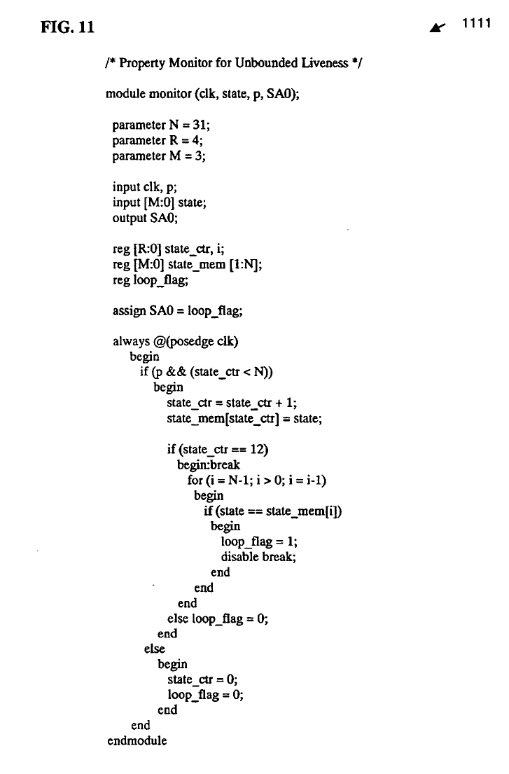

Thus, other embodiments may be realized. For example, FIG. 11 is an exemplary generic monitor 1111 written in the Verilog hardware description language for checking unbounded liveness according to various embodiments of the invention. In this case, the monitor 1111 is written to check for counterexamples with up to thirty-one time steps, using a monitor state machine having up to fifteen states.

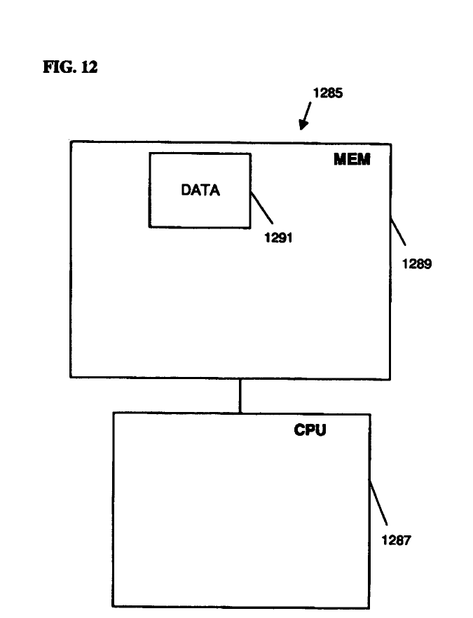

As another example, FIG. 12 is a block diagram of an article 1285 according to various embodiments of the invention. Such embodiments may comprise a computer, a memory system, a magnetic or optical disk, some other storage device, or any type of electronic device or system. The article 1285 may include one or more processors 1287 coupled to a machine-accessible medium such as a memory 1289 (e.g., a memory including an electrical, optical, or electromagnetic conductor). The medium may contain associated information 1291 (e.g., computer program instructions, data, or both) which, when accessed, results in a machine (e.g., the processor(s) 1287) performing activities including selecting a monitor associated with a property of a circuit module. Additional activities may include augmenting the circuit module with the monitor to provide an augmented circuit, searching for a test for an output of the augmented circuit to find a sequence of states having a length up to n, searching from a given starting state (which may comprise an unknown starting state), and if the test is found within the sequence of states, establishing a witness to the property (e.g., determining the property, which may be a safety property and/or a liveness property, to be true). If the test is not found within the sequence of states, activities may include determining the property to be false for a bound of n.

Various embodiments have been used to conduct benchmark testing against conventional approaches, such as BMC. For example, some embodiments have been applied to the ISCAS 89 benchmark circuits (e.g., as described by F. Brglez, et al. in “Combinational Profiles of Sequential Benchmark Circuits”, Proc. IEEE 1989 Int'l Symposium on Circuits and Systems, May 1989, pp 1924-1934, incorporated herein by reference in its entirety) and the GL85 processor design (i.e., a fully functional model and clone of the Intel® 8085 microprocessor, as noted in the 1999 17TH IEEE VLSI Test Symposium, “Verification of Processor Microarchitectures,” Jian Shen and Jacob A. Abraham, p. 189, 1999, incorporated herein by reference in its entirety).

Existential properties were mapped into the monitor circuit which was attached to the circuit design to be checked. A commercial sequential ATPG tool provided by Mentor Graphics Corporation of Wilsonville, Oreg., and based on the BACK algorithm (as described by W. -T. Cheng, “The BACK Algorithm For Sequential Test Generation,” Proceedings International Conference on Computer Design, August 1988, pp. 66-69, incorporated herein by reference in its entirety), was used to generate witnesses. The results were compared with a free research version of a bounded model checker (a BMC program originally from Carnegie-Mellon University) obtained from Cadence Berkeley Labs. To implement the testing process, experiments were performed on a Sun Microsystems Ultrasparc II system with 1 Gbyte memory and dual processors running at 450 MHz.

A set of simple properties were generated on the sequential ISCAS 89 benchmark circuits to compare the two approaches (i.e., the ATPG operations described herein and a previously-known BMC process). Safety and liveness properties were derived by logical composition of all the outputs without any specific distinction.

LTL properties were chosen to demonstrate that sequential ATPG may be used for bounded model checking. However, the monitors described were also found to be suitable for checking CTL properties. BMC for ACTL is the same as LTL property checking, while the existential properties (ECTL) of CTL may be directly mapped into the monitor circuits. If no witness for the property was found (e.g., if the fault was untestable), that meant the property did not hold true. On the other hand, finding a witness proves the property was true within the bound specified.

For each of the ISCAS 89 benchmark circuits, an LTL property was chosen: G((o₀*o₁*o₂ . . . *oₖ)=0), where oᵢ is the i^{th} output of the circuit. Thus, the check was implemented to determine if for all times in the future the circuit would have at least one output which is zero. ATPG was used to find a witness for EF((o₀*o₁*o₂ . . . *oₖ)=1), that is, a state where all outputs were simultaneously equal to one.

In checking the EFp property for an AND function of all outputs, with a bound of n=15, the ATPG approach required no more than 2.2 seconds for checking any of the ISCAS 89 benchmark circuits. However, using the BMC approach, some of the ISCAS 89 benchmark circuit checks required more than 64 seconds, and in some cases (the largest circuits) the BMC approach was completely unable to generate SAT clauses, and failed to validate the property in question.

The liveness property for the benchmark circuits was selected to be F((o₀*o₁* o₂ . . . *oₖ)=0), where oᵢ was the i^{th} output of the circuit. Thus, there is assumed to be a sequence of states of length n (the chosen bound), within which some output will be zero. ATPG was used to find a witness for EG((o₀*o₁*o₂ . . . *oₖ)=1), that is, a sequence of states of length n where all outputs were simultaneously equal to one. This may be accomplished by attempting to generate a test for “stuck at zero” for the property monitor circuit, which ensures that p=o₀*o₁*o₂ . . . *oₖ=1 at every state along the path.

In checking the EGp property for an AND function of all outputs, with a bound of n=15, the ATPG approach required no more than 4.2 seconds for checking any of the ISCAS 89 benchmark circuits. However, using the BMC approach, some of the ISCAS 89 benchmark circuit checks required more than 37 seconds, and in a few cases (the largest circuits) the BMC approach was again completely unable to generate a useful verification result.

In summary, with respect to benchmark results for the ISCAS 89 circuit models, the memory use for the ATPG approach was determined to be about 35 to 50 Mbytes, while the BMC approach used about 150 Mbytes in evaluating the largest circuits for which results could be obtained. The time required for the ATPG approach was relatively consistent, with little increase in relation to circuit size, whereas the time required increased dramatically with the size of the circuit being checked with the BMC approach.

Similar benchmark testing was conducted using the GL85 processor model. The Verilog GL85 implementation included 238 flip-flops, 10084 gates and 18 inputs. Testing selected properties (e.g., ROIA: Reset On Interrupt Acknowledge—always true that interrupt-acknowledge is disabled when the system is reset; RORW: Reset On Read Write—always true that on system reset, read and write signals are rendered inactive; ROTF: Reset On Tstates Flow—always true that on system reset, the machine is driven to the initial “Tstate”; ROIE: Reset On Interrupt Enable—always true that on system reset, interrupt process is disabled; TOPE: Trap On Priority Encoding—always true that priority encoding is disabled when TRAP is active; and RWIO: Reset While Interrupt On—always true that on system reset, machine initializes even while interrupted) yielded some interesting results. The ATPG approach rendered verification in only tens of seconds, as opposed to the BMC approach, which used thousands of seconds.

Implementing the apparatus, systems, and methods disclosed herein may permit checking circuit designs without direct modification by using an external monitor circuit to observe design circuit nodes so as to guide the operation of an existing ATPG tool. Thus, verification may be performed on a model that is relatively close to the final hardware implementation at the logic gate level, providing greater credibility and confidence in the final design. In many cases, larger designs may be checked more thoroughly, with fewer resources, and with greater speed.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus, comprising:
a counterexample monitor for a property; and
a circuit module associated with the property and coupled to the counterexample monitor.

2. The apparatus of claim 1, wherein the counterexample monitor includes temporal logic.

3. The apparatus of claim 1, wherein the property includes a propositional formula p augmented by tense operators selected from at least one of F, G, U, and X, and path quantifiers selected from at least one of A and E.

4. The apparatus of claim 1, wherein the property is selected from a group comprising at least one of EFp, EGp, EXp, EpUq, AFp, AGp, AXp, and ApUq.

5. The apparatus of claim 1, wherein the circuit module includes a processor.

6. The apparatus of claim 1, wherein the property includes at least one of a safety property and a liveness property.

7. The apparatus of claim 1, wherein the property includes an unbounded liveness property.

8. The apparatus of claim 7, wherein the unbounded liveness property is satisfied for a sequence of states including a repeating state.

9. A system, comprising:
a counterexample monitor for a property;
a circuit module associated with the property and coupled to the counterexample monitor; and
an automatic test pattern generator capable of being communicatively coupled to the circuit module.

10. The system of claim 9, wherein the automatic test pattern generator comprises a sequential automatic test pattern generator.

11. The system of claim 9, wherein the automatic test pattern generator comprises a computer.

12. A method, comprising:
selecting a monitor associated with a property of a circuit module;
augmenting the circuit module with the monitor to provide an augmented circuit;
searching for a test for an output of the augmented circuit to find a sequence of states having a length up to n;
establishing a witness to the property if the test is found; and
if no test is found to exist within the sequence of states, determining the property to be false for a bound of n.

13. The method of claim 12, wherein the method comprises finding a counterexample to a property of the circuit module.

14. The method of claim 12, wherein the property is selected from at least one of a safety property and a liveness property.

15. The method of claim 12, further comprising:
searching for the test from a given starting state.

16. The method of claim 12, further comprising:
searching for the test from an unknown starting state.

17. The method of claim 12, wherein the property can be expressed using temporal logic.

18. The method of claim 17, wherein the property includes a propositional formula p augmented by tense operators selected from at least one of F, G, U, and X, and path quantifiers selected from at least one of A and E.

19. The method of claim 12, wherein the property is selected from a group comprising EFp, EGp, EXp, EpUq, AFp, AGp, AXp, and ApUq.

20. An article comprising a machine-accessible medium having associated data, wherein the data, when accessed, results in a machine performing:
selecting a monitor associated with a property of a circuit module;
augmenting the circuit module with the monitor to provide an augmented circuit;
searching for a test for an output of the augmented circuit to find a sequence of states having a length up to n;
establishing a witness to the property if the test is found; and
if no test is found to exist within the sequence of states, determining the property to be false for a bound of n.

21. The article of claim 20, wherein the method comprises finding a counterexample to a property of the circuit module.

22. The article of claim 20, wherein the property is selected from at least one of a safety property and a liveness property.

23. The article of claim 20, wherein the machine-accessible medium further includes data, which when accessed by the machine, results in the machine performing:
searching for the test from a given starting state.

24. The article of claim 20, wherein the machine-accessible medium further includes data, which when accessed by the machine, results in the machine performing:
searching for the test from an unknown starting state.

25. The article of claim 20, wherein the property includes a propositional formula p augmented by tense operators selected from at least one of F, G, U, and X, and path quantifiers selected from at least one of A and E.

26. A method, comprising:
selecting a monitor associated with a property of a circuit module;
augmenting the circuit module with the monitor to provide an augmented circuit; and
searching for a test for an output of the augmented circuit to find a sequence of states including a repeating state that satisfy the property.

27. The method of claim 26, wherein the property can be expressed using temporal logic selected from Linear-Time Temporal Logic (LTL) and Computation Tree Logic (CTL).

28. The method of claim 26, wherein the test comprises finding a counterexample to a universal property associated with the property.
